(19) United States
(12) Patent Application Publication
(10) Pub. No.: US 2025/0331540 A1
(43) Pub. Date: Oct. 30, 2025

(54) ACOUSTIC TREATMENT OF FERMENTED FOOD PRODUCTS

(71) Applicant: John Martin, Oak Park, IL (US)

(72) Inventor: John Martin, Oak Park, IL (US)

(21) Appl. No.: 19/044,608

(22) Filed: Feb. 3, 2025

Related U.S. Application Data
(63) Continuation-in-part of application No. 17/206,349, filed on Mar. 19, 2021, now abandoned.
(60) Provisional application No. 63/011,053, filed on Apr. 16, 2020.

(51) Int. Cl. A23L 5/30

(52) U.S. Cl. CPC A23L 5/30

(57) ABSTRACT

A method for enhancing metabolite content formation rate of a food product under fermentation is disclosed. The method comprises: storing the food product under fermentation; arranging at least one acoustic device to produce at least one sound. The method further comprising: exposing the stored food product to the at least one sound with at least one first tempo (x) for a first time period; changing the at least one first tempo (x) to at least one second tempo (y); exposing the stored food product to the at least one sound with the at least one second tempo (y) for a second time period; and yielding a change in the metabolite content formation rate of the fermented food product.

### CROSS-REFERENCE TO RELATED APPLICATION

This application is a continuation-in-part of U.S. application Ser. No. 17/206,349, filed on Mar. 19, 2021, which claims priority to U.S. Provisional Application No. 63/011,053, filed on Apr. 16, 2020.

### BACKGROUND

### Field of Invention

The present invention relates to a method for modifying a food product by acoustically treating such a product or a precursor used to make such a product. Such acoustic treatment involves exposing the food product, or precursor thereof, to sound.

### Description of Related Art

Fermentation is a biological process for extracting energy from molecules. During the fermentation, carbohydrates are converted to alcohol, organic acids, carbon dioxide, and/or other metabolites.

Fermentation plays a central role in the production of various food products, including bread, buttermilk, cocoa, cheese, cured meats, fish sauce, kefir, kimchi, kombucha, kvass, miso, pickled vegetables, poi, sauerkraut, soy sauce, vinegar, yogurt, beer, cider, liquor, mead, mescal, sake, spirits, tequila, and wine. Fermentation is typically carried out by bacteria or fungi, such as yeast, present in the food product or a precursor of the food product.

In food processing, fermentation is used to convert carbohydrates in the food product (or a precursor used to make the food product) into alcohol, organic acids, carbon dioxide, and/or other metabolites, thus leading to changes in the taste, texture, aroma, and/or other properties of the food product. For example, wine is produced by way of fermentation of fruit juices, thus leading to the conversion of sugar in such juices to alcohol. Further, carbon dioxide produced by fermentation causes bread to leaven. Organic acids produced during the fermentation of milk cause the formation of yogurt and cheese. An additional benefit to fermentation is that the organic acid produced may serve to preserve the food product.

It is known in the art that sound has a role in the processing of food. For example, the growth of plants has been shown to be affected by sound. See Collins et al., Canadian Acoustics, 29 (2) (2001) and Chatterjee et al., Asian J. Plant Sci. Res., 3:28-30 (2013). In fact, the type of music played has been shown to have different effects on the growth of plants. See Ekici et al., Asian Journal of Plant Sciences, 6:369-373 (2007). In addition, it has been demonstrated that the use of sound may accelerate the aging of wines. See Risen, C. (2012 Aug. 21). Rolling out a smaller barrel sooner. New York Times. p. D5. Sound has also been used to enhance the flavor of food. See U.S. Pat. No. 8,197,873.

Sound has been shown to affect fermentation. For example, it has been demonstrated to accelerate the growth of yeast and to significantly decrease fermentation time. See Aggio et al., Metabolomics, 8:670-678 (2012), Jomdecha et al., In 12th Asia-Pacific Conference on NDT, 5-10 Nov. 2006, Auckland, New Zealand. In addition, sound has been shown to stimulate ethanol production. Klomklieng et al., IPCEE, 9:234-239 (2011). Sound has thus been used in the production of wine. An Austrian winemaker has loudspeakers on his vineyards and plays classical music for them day and night. See Kuderski, A., This Austrian Winemaker Is Using Music to Ferment His Wines. (2014 Dec. 23), Vice.

Thus, there is a need for a method for enhancing metabolite content formation rate of a food product under fermentation.

### SUMMARY

The present invention relates to a method for enhancing metabolite content formation rate of a food product under fermentation. The method comprising steps of: storing the food product under fermentation; arranging at least one acoustic device to produce at least one sound; exposing the stored food product to the at least one sound with at least one first tempo (x) for a first time period. The at least one first tempo (x) is a number of beats percussion by the at least one sound in a minute; changing the at least one first tempo (x) to at least one second tempo (y). The at least one second tempo (y) is the number of beats percussion by the at least one sound in the minute; exposing the stored food product to the at least one sound with the at least one second tempo (y) for a second time period; and yielding a change in the metabolite content formation rate of the fermented food product.

The present invention relates to a method for enhancing metabolite content formation rate of a food product under fermentation. The method comprising steps of: exposing the food product to the at least one first sound, using more than one acoustic devices, with at least one first tempo (x) for a first time period. At least one first tempo (x) is a number of beats percussion by the at least one sound in a minute; changing the at least one first tempo (x) to at least one second tempo (y). The at least one second tempo (y) is the number of beats percussion by the at least one sound in the minute; exposing the food product to the at least one second sound, using the more than one acoustic devices, with the at least one second tempo (y) for a second time period; and yielding a change in the metabolite content formation rate of the fermented food product.

The present invention relates to a method for enhancing metabolite content formation rate of a food product under fermentation. The method comprising steps of: exposing the food product to at least one first tempo (x) of at least one sound for a first time period. The at least one first tempo (x) is a number of beats percussion by the at least one sound in a minute; changing the at least one first tempo (x) to at least one second tempo (y). The at least one second tempo (y) is the number of beats percussion by the at least one sound in the minute; exposing the food product to the at least one second tempo (y) of the at least one sound for a second time period, wherein the at least one first tempo (x) and the at least one second tempo (y) of the at least one sound are in a range from 60 beats per minute (bpm) to 200 beats per minute (bpm); and yielding a change in the metabolite content formation rate of the fermented food product.

The present invention also relates in part to a fermented food product produced using such a method.

### BRIEF DESCRIPTION OF THE DRAWINGS

FIG. 1 depicts a setup for an acoustic treatment of a mixture contained in a fermenter using an external acoustic device.

FIG. 2 depicts a setup for the acoustic treatment of a mixture contained in a fermenter using a submerged acoustic device.

FIG. 3 depicts a graph representing pH levels measured over time of a control batch, a batch acoustically treated using an external acoustic device and a batch acoustically treated at 96 beats per minute (bpm) using a submerged acoustic device.

FIG. 4 depicts a graph representing sugar levels measured over time in a control batch, a batch acoustically treated using an external acoustic device and a batch acoustic treated at different beats using a submerged acoustic device.

FIG. 5 depicts a graph representing an Ultraviolet (UV) spectrum analysis of aliquots from a control batch and a batch acoustically treated using a submerged acoustic device.

FIG. 6 depicts a graph representing the sugar levels measured over time in a control batch, a batch acoustically treated using an external acoustic device and a batch acoustically treated using a submerged acoustic device.

FIG. 7 depicts a graph representing a metabolite content formation rate measured over time.

FIG. 8 depicts a graph representing the metabolite content formation rate measured over time.

FIG. 10 depicts a flowchart of a method for enhancing metabolite content formation rate of a food product under fermentation using an acoustic device.

FIG. 11 depicts a flowchart of a method for enhancing metabolite content formation rate of a food product under fermentation using acoustic devices.

### DETAILED DESCRIPTION

The present invention relates to a method for modifying the flavor of a food product by acoustically treating such a product or a precursor used to make such a product. Such acoustic treatment involves exposing the food product, or precursor thereof, to sound. A “precursor,” as used herein refers to any ingredient or any combination of the same (e.g., dough) used in the process of making the final fermented food product.

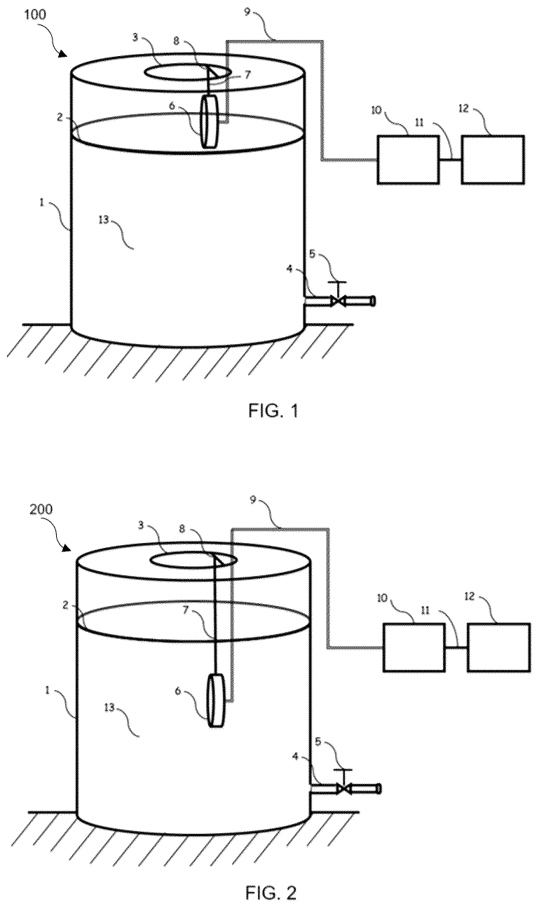

FIG. 1 depicts a setup 100 for an acoustic treatment of a mixture using an external acoustic device. As depicted in the FIG. 1, the setup 100 may include a fermenter 1, a mash fill line 2, an open area 3, a drain 4, a shut off valve 5, an acoustic device 6, a stationary line 7, a bracket 8, a speaker wire 9, an amplifier 10, an audio input wire 11, an audio input 12, and a beer mash 13.

The fermenter 1 may be constructed of any material such as, but not limited to, a metallic material, a carbon fiber material, a plastic material, a ceramic material, and so forth. In a preferred embodiment of the present invention, the fermenter 1 may be constructed of a stainless steel material. Embodiments of the present invention are intended to include or otherwise cover any material for construction of the fermenter 1, including known, related art, and/or later developed technologies.

An example of the setup 100 wherein the acoustic device 6 may be external to the fluid material that may be fermented may be depicted in the FIG. 1. The sound may be produced by any device capable of producing a sound (referred to herein as an “acoustic device”). The acoustic device 6 may, for example, be a speaker, a transducer, or a musical instrument. In the FIG. 1, the fermenter 1 may be a tank, a container, and so forth. The fermenter 1 in this example contains the beer mash 13 that may be filled to the mash fill line 2. The fermenter 1 contains the open area 3 through which the acoustic device 6 may be suspended using the stationary line 7 from the bracket 8 attached to the sides of the fermenter 1. The acoustic device 6 serves as the acoustic device 6 and may be suspended above the mash fill line 2. The acoustic device 6 may be connected by way of the speaker wire 9 to the amplifier 10 and the audio input 12 by way of the audio input wire 11. The fermenter 1 has the drain 4 which leads to the shut off valve 5.

FIG. 2 depicts a setup 200 for the acoustic treatment of the mixture using a submerged acoustic device. The acoustic treatment of the mixture contained in the fermenter 1 may be conducted using the acoustic device 6 submerged in the fermenter 1. An example of the setup 200 wherein the acoustic device 6 may be submerged in the fluid material that may be fermented may be depicted in the FIG. 2. In the FIG. 2, the fermenter 1 may be the fermenter 1. The fermenter 1 in this example contains the beer mash 13 that may be filled to the mash fill line 2. The fermenter 1 contains the open area 3 through which the speaker 6 may be suspended using the stationary line 7. The acoustic device 6 may be suspended so that it may be below the mash fill line 2 and thus submerged in the beer mash 13 when the fermenter 1 may be filled with the mash. The acoustic device 6 may be connected by way of the speaker wire 9 to the amplifier 10 and the audio input 12 by way of the audio input wire 11. The fermenter 1 has the drain 4 which leads to the shut off valve 5.

The acoustic treatment may be applied to any food product produced or preserved by fermentation. Such food products are referred to herein as “fermented food products”. Examples of such fermented food products include bread, buttermilk, cocoa, cheese, cured meats, fish sauce, kefir, kimchi, kombucha, kvass, miso, pickled vegetables, poi, sauerkraut, soy sauce, vinegar, and yogurt. The fermented food product may be an alcoholic beverage such as beer, cider, liquor, mead, mescal, sake, spirits, tequila, wine, or combinations thereof. The acoustic treatment may further enhance a taste of the fermented food products by manipulating a percentage (%) of sugar. In some embodiments, the acoustic treatment may enhance the taste of the fermented food products by reducing the percentage (%) of the sugar. In some embodiments, the acoustic treatment may enhance the taste of the fermented food products by increasing the percentage (%) of the sugar. The percentage (%) of the sugar may be measured using an unit of Brix. The Brix measurement unit may denote an amount of the sugar dissolved in the fermented food products.

In some embodiments, depending on when fermentation occurs during the process for the production of the fermented food product, the acoustic treatment may be applied to a precursor of that product. For example, the process of making cocoa involves the fermentation of cacao beans. As such, the method of the present invention may involve the acoustic treatment of the cacao beans that may be later used to produce the final fermented food product, cocoa. For the sake of convenience, the present application may use the term “material” to refer to the fermented food product or precursor thereof that may be subjected to acoustic treatment.

The invention contemplates the use of sound in any form. For example, the sound may be in the form of music, tones, infrasound, or ultrasound.

In certain embodiments of the present invention, the sound may be produced by the audio input 12 such as an MP3 player, a computer, a musical instrument, a radio, a tape player, or a microphone linked to the acoustic device 6. Further, a tempo of the sound has effects on the consumption of carbohydrates and the production of acids and certain metabolites during fermentation. It may be believed that the rate of fermentation may be affected by the tempo of sound. As such, it may be believed that the rate of carbohydrate consumption and the production of carbon dioxide, alcohol, and other metabolites produced during fermentation may be affected. The metabolites produced may, for example, be organic acids, fuel oils, esters, aldehydes, glycerol, certain flavor compounds, and/or any other metabolite normally produced during fermentation.

At one instance, a sound having a slower tempo, for example below 100 beats per minute (bpm), has been shown to decrease a rate of the sugar consumption and increase the production of acids and certain metabolites. For example, the production of certain flavor compounds such as those having caramel notes was shown to be increased. It may be believed that the treatment using sound having such slower tempos may also decrease alcohol and carbon dioxide production.

In certain embodiments, the tempo of the sound may be below about 100 beats per minute (bpm), for example below about 95, below about 90, below about 85, below about 80, below about 79, below about 60, below about 50, below about 40, below about 30, below about 20, or below about 10 beats per minute (bpm). In certain embodiments, the tempo may be between about 50 and about 100 beats per minute (bpm), between about 60 and about 100 beats per minute (bpm), between about 70 and about 100 beats per minute (bpm), between about 75 and about 95 beats per minute (bpm), or between about 80 and about 90 beats per minute (bpm).

At another instance, a sound having a faster tempo, for example above 100 beats per minute (bpm), may have been shown to increase the rate of the sugar consumption and increase carbon dioxide and alcohol production. It may be also expected to decrease the production of acids and other metabolites.

In an embodiment of the present invention, the tempo of the sound may be above about 100 beats per minute (bpm), for example above about 110 beats per minute (bpm), above about 150 beats per minute (bpm), above about 200 beats per minute (bpm), above about 250 beats per minute (bpm), or above about 300 beats per minute (bpm). In certain embodiments, the tempo may be between about 100 and about 300 beats per minute (bpm), between about 100 and about 250 beats per minute (bpm), between about 100 and about 225 beats per minute (bpm), between about 100 and about 200 beats per minute (bpm), between about 120 and about 180 beats per minute (bpm), or between about 130 and about 160 beats per minute (bpm).

The present invention further contemplates that the sound may be of any decibel level as long as it may be loud enough to have an effect on fermentation and not so loud as to be damaging to fermentation and/or the equipment. The decibel level of the sound may be, for example, from about 0.01 to about 1,000 decibel (dB), about 0.01 to about 500 decibel (dB), about 0.01 to about 200 decibel (dB), or about 100 decibel (dB).

The acoustic treatment may take place for as much time as required to achieve the desired effect on the material. For example, the treatment may be for more than 30 days, up to about 30 days, up to about 25 days, up to about 20 days, up to about 15 days, up to about 10 days, up to about 9 days, up to about 8 days, up to about 7 days, up to about 6 days, up to about 5 days, up to about 96 hours, up to about 84 hours, up to about 72 hours, up to about 60 hours up to about 48 hours, up to about 36 hours, up to about 24 hours, up to about 12 hours, up to about 6 hours, up to about 3 hours, up to about 2 hours, up to about 1 hour, or up to about a half hour. In certain embodiments, the acoustic treatment takes place over the entire course of fermentation, up to about 75 percent (%) of the course of the fermentation, up to about 50 percent (%) of the course of the fermentation, up to about 25 percent (%) of the course of the fermentation, up to about 10 percent (%) of the course of the fermentation, or up to about 5 percent (%) of the course of the fermentation.

The present invention contemplates that the sound may be of any frequency, including frequencies outside of the range audible to humans. For example, the sound may be ultrasound or infrasound. The frequency of the sound may be, for example, from about 10 Hertz (Hz) to about 25,000 Hertz (Hz), from about 10 Hertz (Hz) to about 500 Hertz (Hz), or from about 10 Hertz (Hz) to about 250 Hertz (Hz).

In an embodiment of the present invention, the material may be positioned at any distance from the acoustic device 6, as long as the acoustic waves from the source may be felt by the material. The material may, for example, be up to about 50 feet (ft) from the acoustic device 6. In certain embodiments, it may be up to about 25 feet (ft), up to about 20 feet (ft), up to about 15 feet (ft), up to about 10 feet (ft), up to about 5 feet (ft), up to about 3 feet (ft), up to about 2 feet (ft), up to about 1 foot (ft), up to about 6 inch (in), up to about 3 inch (in), up to about 2 inch (in), or up to about 1 inch (in) from the acoustic device 6.

In an embodiment of the present invention, the material subjected to the acoustic treatment may be in the form of a fluid, for example, a liquid, a solution, or a fluid mixture, the acoustic device 6 may be submerged in the fluid. In an embodiment of the present invention, the fluid may be contained in the fermenter 1 and the acoustic device 6 may be submerged within the fermenter 1. In another embodiment of the present invention, the acoustic device 6 may be external to the fluid, for example, hung above it or at a position beside it.

The acoustic device 6 may be, for example, a speaker, a music system, a loudspeaker, a mobile device, and so forth.

In an embodiment of the present invention, the acoustic device 6 may be arranged proximate to the fermenter 1 to produce a sound. In certain embodiments wherein the acoustic devices 6 may be arranged proximate to the fermenter 1 to produce the sound. In an embodiment of the present invention, ‘n’ number of the acoustic devices 6 may be arranged proximate to the fermenter 1, wherein ‘n’ may be any natural number greater than 1.

In an embodiment of the present invention, the acoustic device 6 may be adapted to produce the sound with a first tempo (x) for a first time period. The first tempo (x) may be a number of beats percussion by the sound in a minute. Further, the acoustic device 6 may be adapted to produce the sound with a second tempo (y) for a second time period. The second tempo (y) may be the number of beats percussion by the sound in the minute. In certain embodiments, the sound with the first tempo (x) and the sound with the second tempo (y) may be produced combinedly with the acoustic device 6. In another embodiments, the sound with the first tempo (x) and the sound with the second tempo (y) may be produced simultaneously with the acoustic device 6. In yet another embodiments, the sound with the first tempo (x) and the sound with the second tempo (y) may be produced individually by the acoustic devices 6.

In an embodiment of the present invention, the first tempo (x) and the second tempo (y) of the sound may be in a range from 46 beats per minute (bpm) to 400 beats per minute (bpm). In an exemplary embodiment, the first tempo (x) of the sound may be 46 beats per minute (bpm) that may be increased up to the second tempo (y) of the sound, which may further be 400 beats per minute (bpm). In another exemplary embodiment, the first tempo (x) of the sound may be 400 beats per minute (bpm) that may be decreased up to the second tempo (y) of the sound, which may be 42 beats per minute (bpm).

In an embodiment of the present invention, a frequency of the sound may be in a range from 119 Hertz (Hz) to 197 Hertz (Hz). In certain embodiments wherein the decibel level of the sound may be in a range from 0.01 decibel (dB) to 200 decibel (dB) with respect to a surface of the fermented food product. In an embodiment of the present invention, the first time period and the second time period may be in a range from 0 hours to 72 hours. Embodiments of the present invention are intended to include or otherwise cover any first tempo (x) and second tempo (y) of the sound, any frequency of the sound, cover any decibel level of the sound, and cover any first time period and the second time period.

In an embodiment of the present invention, the acoustic device 6 may be controlled by a computing device (not shown) to dynamically adjust the tempo, frequency, and decibel level of the sound based on feedback received from sensors. For example, the sensors may detect changes in the chemical composition, temperature, or texture of the fermented food product during the fermentation process. The computing device may process this feedback and adjust the acoustic device 6 to produce a sound with a specific tempo, frequency, and decibel level optimized for the current stage of fermentation. In another embodiment of the present invention, the acoustic device 6 may emit alternating patterns of sound with the first tempo (x) and the second tempo (y) at predefined intervals, such as 30-second cycles. The frequency and amplitude of the sound may be modulated in synchronization with these intervals to enhance the efficacy of fermentation by promoting microbial activity in the fermented food product.

In yet another embodiment of the present invention, the acoustic devices 6 may be plurality in numbers such as each acoustic device 6 may produce sounds of varying tempos and frequencies at different locations on or around the fermented food product. This configuration may be used to create a controlled acoustic field that ensures uniform exposure of the fermented food product to the acoustic energy, thereby improving consistency in the fermentation process. In a further embodiment of the present invention, the acoustic device 6 may be equipped with a memory module (not shown) storing preconfigured sound profiles. These sound profiles may be customized for different types of fermented food products, such as dairy, grains, or vegetables, and may include variations in tempo, frequency, and decibel levels to cater to specific microbial strains or fermentation requirements. The computing device may select and apply a specific sound profile based on the type of fermented food product being processed.

In an embodiment of the present invention, the acoustic device 6 may be submerged in the fluid, submerged so that it may be less than about 20 feet (ft), less than about 15 feet (ft), less than about 10 feet (ft), less than about 5 feet (ft), or about 4 feet (ft) below the surface of the fluid. In an embodiment of the present invention, the acoustic device 6 may be submerged in the fluid, the acoustic device 6 may be omnidirectional. In another embodiment of the present invention, the acoustic device 6 may be submerged in the fluid, more than one acoustic device 6 may be present within the fluid. In such an embodiment of the present invention, one acoustic device 6 may be present, for example, every about 2,000 to about 8,000 square feet (sqft), every about 3,000 to about 7,000 square feet (sqft), or every about 4,500 to about 6,000 square feet (sqft) of the fluid, or every 27,000 cubic feet (cuft) an additional acoustic device 6 can be used in tandem.

In an embodiment of the present invention, more than one material may be subjected to the acoustic treatment simultaneously. For example, sound from one acoustic device 6 may be used to treat a bread and a cheese that may be both exposed to the same sound. Also, sound from the acoustic device 6 submerged in the fermenter 1 containing wine may be used to also treat beer contained in another fermenter 1. It may be further used to treat cheese that may be in the same room and exposed to the same sound. In another embodiment of the present invention, a cheese may be contained in a compartment that may be submerged along with the acoustic device 6 in the fermenter 1 containing wine with the sound from that acoustic device 6 used to treat both the wine and the cheese.

As discussed previously, when the material to be treated may be a fluid, it may be contained in the fermenter 1. Examples of such fermenter 1 include a container, tanks, and so forth. The fermenter 1 may, for example, have a volume of about 10 gallons to about 100 gallons, about 20 gallons to about 90 gallons, about 30 gallons to about 80 gallons, about 40 gallons to about 70 gallons, or about 55 gallons.

The material may comprise a microorganism and/or an enzymatic preparation (for example, containing amylase) to assist in the fermentation. For example, the material may be in the form of a fluid mixture containing such a microorganism and/or enzymatic preparation.

The microorganism may be a bacteria, a fungus such as yeast.

Fermentation may, for example, be terminated after about 96 hours, after about 72 hours, after about 60 hours, after about 48 hours, after about 36 hours, after about 24 hours, after about 12 hours, or after about 6 hours. The termination of the fermentation may be accomplished by means known in the art, for example by a thermal treatment (distillation for alcohol and pasteurization for dairy materials and beverages), freezing, or the use of pressure or heat.

In certain embodiments, acoustic treatment has the effect of increasing or decreasing the growth rate of the microorganism.

In certain embodiments, acoustic treatment has the effect of increasing or decreasing the yield of the fermented food product.

In certain embodiments, the fermented food product may be exposed to the sound produced. The exposure of the fermented food product facilitates a change in the metabolite content formation rate of the fermented food product. Furthermore, the change in the metabolite content may be yielded. In certain embodiments, the metabolite content formation rate may be the percentage (%) of the sugar in the fermented food product. In certain embodiments, the exposure of the fermented food product to the sound concentrates the metabolite content formation rate in the fermented food product from 16.5 percent (%) to 4 percent (%). In other words, the exposure of the fermented food product to the sound concentrates the percentage (%) of the sugar from 16.5 percent (%) to 4 percent (%). In certain embodiments, the exposure of the fermented food product to the sound concentrates a pH level of the fermented food product in a range from 4.31 to 5.9. In certain embodiments of the present invention, the exposure of the fermented food product to the sound concentrates an alcohol content of the fermented food product in a range from 12 percent (%) to 18 percent (%).

The present invention also relates to the fermented food product produced using the method of the present invention. In certain embodiments, the fermented food product may be in a liquid form or a semi-liquid form. In certain embodiments, the fermented food product may be bread, buttermilk, cocoa, cheese, cured meats, fish sauce, kefir, kimchi, kombucha, kvass, miso, pickled vegetables, poi, sauerkraut, soy sauce, vinegar, yogurt, beer, cider, liquor, mead, mescal, sake, spirits, tequila, or wine.

The ability of acoustic treatment to affect the sugar, alcohol, and acid content and the amount of metabolites such as flavor compounds may be useful in the flavoring of fermented food products, including any of the aforementioned products.

In addition, the ability of acoustic treatment to affect the production of carbon dioxide may be useful in the process of making bread and cheese. For example, the carbon dioxide produced and the modification thereof by way of acoustic treatment will have an effect on the leavening of bread with less carbon dioxide produced leading to less leavened bread and more carbon dioxide produced leading to more leavened bread. Similarly, the amount of carbon dioxide produced and the modification thereof by way of acoustic treatment will have an effect on the structure of the cheese (e.g., the holes in Swiss cheese that may be produced by carbon dioxide).

Further, the ability of acoustic treatment to affect the production of acid may be useful in the process of making cheese, cured meats, kefir, kimchi, kombucha, pickled vegetables, sauerkraut, vinegar, and yogurt.

### EXAMPLES

### Example 1

Dry corn was ground using a hammer mill and then mixed with water to produce a slurry. This slurry was heated to 155 degrees Fahrenheit (° F.) and other adjuncts (including rye and barley) added. The slurry was then allowed to cool. When the temperature of the slurry cooled to 145 degrees Fahrenheit (° F.), enzymes were added to hydrolyze the starch, and the temperature held for 60 minutes to 90 minutes. The mixture was chilled to 100 degrees Fahrenheit (° F.) and inoculated with an active commercial yeast strain capable of converting the sugar into ethanol, carbon dioxide, and other flavor metabolites.

The inoculated mixture was divided into multiple open air fermenters. One batch received no acoustic treatment and served as the control. Another batch received acoustic treatment using the acoustic device 6 external to the mixture. A third batch received acoustic treatment using the acoustic device 6 submerged in the mixture. The acoustic treatment took place over 72 hours and involved sound at 119 Hertz (Hz) to 197 Hertz (Hz), 92 beats per minute (bpm), and 100 decibel (dB). The sound was played using the MP3 player (the audio input 12), the amplifier 10, and the acoustic device 6 as depicted in the FIG. 1 (for the external acoustic device) and the FIG. 2 (for the submerged acoustic device). The contents of the fermenter 1 were not stirred during the process.

Samples were collected and analyzed every 24 hours for the pH level and percentage (%) dissolved solids.

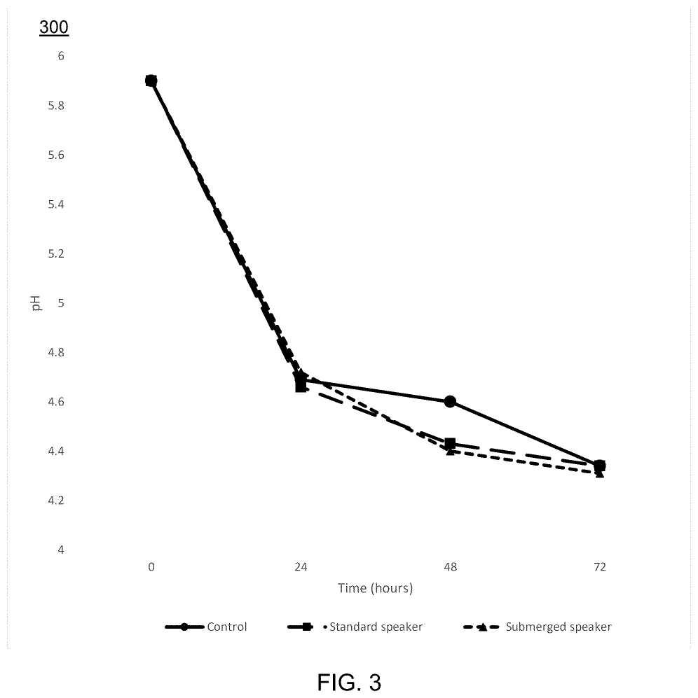

FIG. 3 depicts a graph 300 representing the pH levels measured over time of a control batch, a batch acoustically treated using the external acoustic device, and a batch acoustically treated at 96 beats per minute (bpm) using the submerged acoustic device.

Acoustic processing at 119 Hertz (Hz) to 197 Hertz (Hz), 92 beats per minute (bpm), and 100 decibel (dB) was found to impact the pH level and percentage (%) sugar of the resulting product versus control.

Acoustically-treated batches exhibited a more rapid decrease in pH, whether using the external acoustic device or the submerged acoustic device, as compared to the control batch that was not acoustically treated. This may be indicative of the greater acid production induced by acoustic treatment. These results are summarized in Table 1 and the FIG. 3.

TABLE 1
pH Change Over Time

| | 0 | 24 hours | 48 hours | 72 hours |
|---|---|---|---|---|
| Control | 5.9 | 4.69 | 4.6 | 4.34 |
| External acoustic device | 5.9 | 4.66 | 4.43 | 4.34 |
| Submerged acoustic device | 5.9 | 4.72 | 4.4 | 4.31 |

The increased acidity (lower pH) would result in a taste difference in the product with the final product tasting more sour.

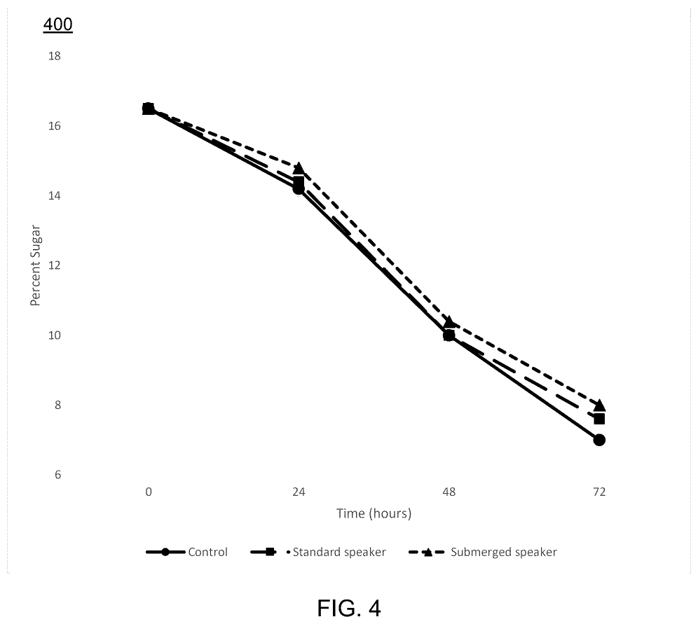

FIG. 4 depicts a graph 400 representing the sugar levels measured over time in the control batch, the batch acoustically treated at different beats using the external acoustic device, and the batch acoustically treated using the submerged acoustic device. Acoustic treatment resulted in slower sugar consumption as compared to the control that was not acoustically treated. The batch treated using the submerged acoustic device exhibited a lower percentage (%) sugar decrease over the fermentation process as compared with the batch treated using the external acoustic device. These results are summarized in Table 2, Table 3, and in the FIG. 4.

TABLE 2
Percent Sugar Over Time

| | 0 | 24 hours | 48 hours | 72 hours |
|---|---|---|---|---|
| Control | 16.5 | 14.2 | 10 | 7 |
| External acoustic device | 16.5 | 14.4 | 10 | 7.6 |
| Submerged acoustic device | 16.5 | 14.8 | 10.4 | 8 |

TABLE 3
Percent (%) Sugar Over Time

| | | | | 200 | 400 | 46/400 | 400/46 |
|---|---|---|---|---|---|---|---|
| Time | 0 bpm | 46 bpm | 92 bpm | bpm | bpm | bpm | bpm |
| 0 hours | 16.5 | 15.5 | 16.5 | 11 | 15.5 | 15.5 | 15.7 |
| 12 hours | 15.3 | 15.4 | 16 | 9.5 | 13 | 15.3 | 13.2 |
| 24 hours | 14.2 | 15.3 | 14.8 | NA | 12 | 15.1 | 12.5 |
| 48 hours | 10 | 12 | 10.4 | NA | 7 | 13 | 11.5 |
| 72 hours | 7 | 10 | 8 | 4 | 7 | 12 | 10 |

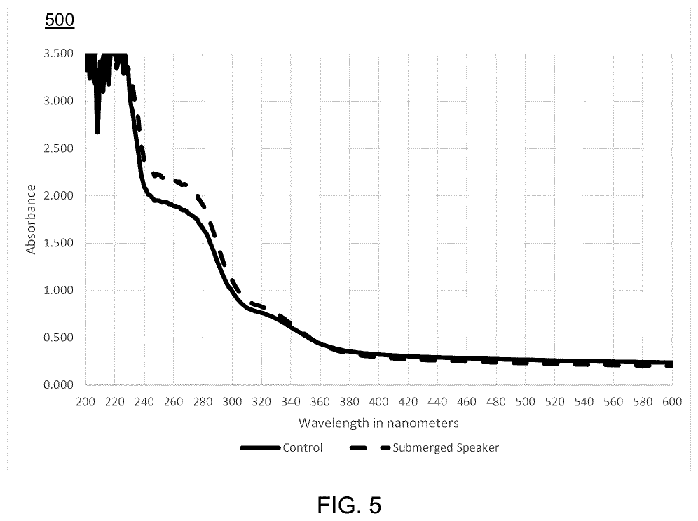

FIG. 5 depicts a graph 500 representing an Ultraviolet (UV) spectrum analysis of aliquots from the control batch and the batch acoustically treated using the submerged acoustic device.

Aliquots of the control batch and the batch treated using the submerged acoustic device were analyzed using UV spectrum analysis of 200 nanometers (nm)-600 nanometers (nm) wavelength to note compositional differences between the two batches (as shown in the FIG. 5). There was a significant increase in flavor compounds noted at around 240-280 nm in the acoustically-treated sample (1-59-3) as compared with control (1-59-1). Compounds at this wavelength are typically associated with caramel notes.

After 72 hours of the acoustic processing, the fermentate was then passed through a distillation column to remove ethanol.

Samples from the batches were filtered and refrigerated to slow further fermentation effects. The samples were tasted by expert panelists within 12 hours (Table 4).

TABLE 4
Expert panel taste comments (n = 3) of filtered control
(1-59-1) and the submerged acoustic device samples
(1-59-3) after 72 hours of the acoustic processing.

| | Taste comments |
|---|---|
| Control sample (no | Beer like, earthy, cotton |
| acoustic processing) | candy, corn meal taste |
| Sample subjected | Beer, earthy notes, |
| to acoustic processing | brown caramelly, |
| using submerged acoustic device | cooked notes. |

### Example 2

The same process as described in Example 1 was used with different amounts of corn and adjuncts.

The inoculated mixture was divided into two open air fermenters. One batch received no acoustic treatment and served as the control. Another batch received acoustic treatment using the acoustic device 6 external to the mixture. The acoustic treatment took place over 72 hours and involved sound at approximately 230 Hertz (Hz), 134 to 168 beats per minute (bpm), and 79 decibel (dB). The sound was played using the external acoustic device as depicted in the FIG. 1. The contents of the fermenter 1 were not stirred during the process.

Samples were collected and analyzed over time for percentage (%) dissolved solids.

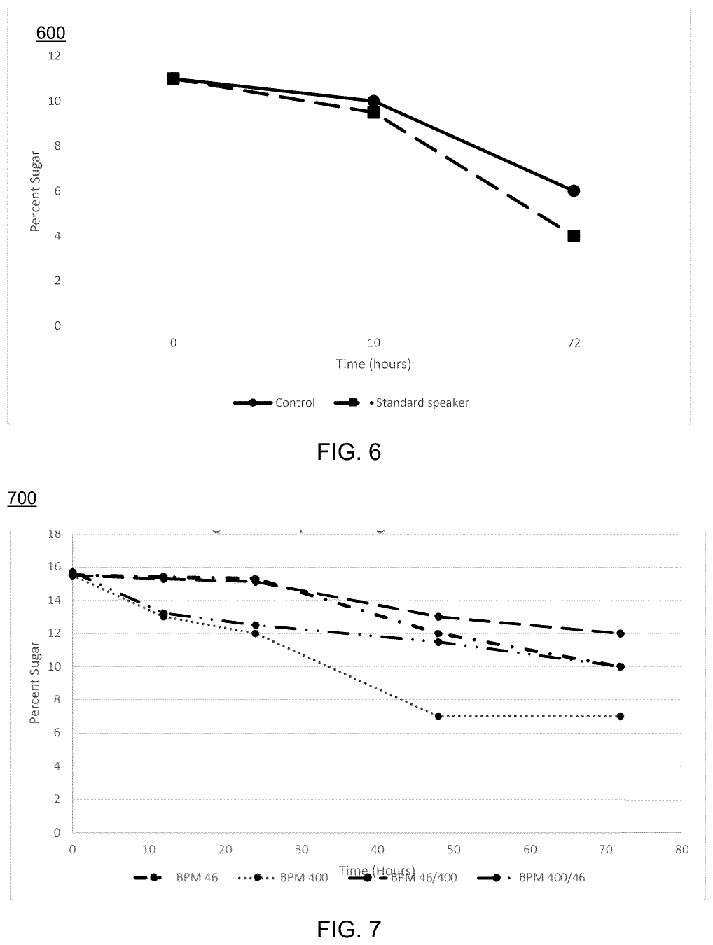

FIG. 6 depicts a graph 600 representing the sugar levels measured over time in the control batch, the batch acoustically treated using the external acoustic device, and the batch acoustically treated using the submerged acoustic device. Acoustic treatment resulted in faster sugar consumption as compared with the control that was not exposed to sound. These results are summarized in Table 5 and in the FIG. 6.

TABLE 5
Percent (% ) Sugar Over Time

| | 0 | 10 hours | 72 hours |
|---|---|---|---|
| Control | 11 | 10 | 6 |
| External acoustic | 11 | 9.5 | 4 |
| device | | | |

After 72 hours of the acoustic processing, the fermentate was then passed through a distillation column to remove ethanol.

Samples from the batches were filtered and refrigerated to slow further fermentation effects. The samples were tasted by expert panelists within 12 hours (Table 5).

TABLE 6
Expert panel taste comments (n = 2) of filtered
control (1-48-1) and external acoustic device samples (1-48-2)
after 72 hours of the acoustic processing.

| | Taste comments |
|---|---|
| Control sample (no acoustic processing) | Vegetative, herbal, bready, sweet |
| Sample subjected to acoustic processing | Vegetative, astringent, harsher than |
| using external acoustic device | control. |

### Example 3

The same process as described in Example 1 was used with different amounts of corn and adjuncts.

The inoculated mixture was divided into two open air fermenters. One batch received no acoustic treatment and served as the control. Another batch received acoustic treatment using the acoustic device 6 submerged in the mixture. The acoustic treatment took place over 72 hours and involved sound at approximately 230 Hertz (Hz), 280 to 320 beats per minute (bpm), and 80 decibel (dB). The sound was played using the MP3 player (the audio input 12), the amplifier 10, and the submerged acoustic device as depicted in the FIG. 2. The contents of the fermenter 1 were not stirred during the process.

The acoustic treatment may result in faster sugar consumption as compared with the control that was not exposed to sound. After 72 hours of the acoustic processing, the fermentate may be then passed through a distillation column to remove ethanol, according to an embodiment of the present invention.

Samples from the batches were filtered and refrigerated to slow further fermentation effects. The samples were tasted by expert panelists within 12 hours (Table 7).

TABLE 7
Expert panel taste comments (n = 4) of filtered control
(1-68-1) and the submerged acoustic device samples (1-68-2)
after 72 hours of the acoustic processing.

| | Taste comments |
|---|---|
| Control sample (no acoustic processing) | Sweet, salty |
| Sample subjected to acoustic processing | Astringent, harsher than control. |
| using submerged acoustic device | |

FIG. 7 depicts a graph 700 representing the metabolite content formation rate measured over time. An x-axis of the graph 700 may represent a number of hours the food product may have undergone the acoustic treatment. An x-axis of the graph 700 may represent a number of hours the food product may have undergone the acoustic treatment. A y-axis of the graph 700 may represent the percentage (%) of the sugar in the food product.

At zero hours of the acoustic treatment using 46 beats per minute (bpm), the food product may contain 15.5 percent (%) of the metabolite content. At 12 hours of the acoustic treatment using 46 beats per minute (bpm), the food product may contain 15.4 percent (%) of the metabolite content. At 24 hours of the acoustic treatment using 46 beats per minute (bpm), the food product may contain 15.3 percent (%) of the metabolite content. Further, at 48 hours of the acoustic treatment using 46 beats per minute (bpm), the food product may contain 12 percent (%) of the metabolite content. At 72 hours of the acoustic treatment using 46 beats per minute (bpm), the food product may reduce to 10 percent (%) of the metabolite content.

At zero hours of the acoustic treatment using 400 beats per minute (bpm), the food product may contain 15.5 percent (%) of the metabolite content. At 12 hours of the acoustic treatment using 400 beats per minute (bpm), the food product may contain 13 percent (%) of the metabolite content. At 24 hours of the acoustic treatment using 400 beats per minute (bpm), the food product may contain 12 percent (%) of the metabolite content. At 48 hours of the acoustic treatment using 400 beats per minute (bpm), the food product may contain 7 percent (%) of the metabolite content. At 72 hours of the acoustic treatment using 400 beats per minute (bpm), the food product may contain 7 percent (%) of the metabolite content.

At zero hours of the acoustic treatment using incremental tempo from 46 beats per minute (bpm) to 400 beats per minute (bpm), the food product may contain 15.5 percent (%) of the metabolite content. At 12 hours of the acoustic treatment using incremental tempo from 46 beats per minute (bpm) to 400 beats per minute (bpm), the food product may contain 15.3 percent (%) of the metabolite content. At 24 hours of the acoustic treatment using incremental tempo from 46 beats per minute (bpm) to 400 beats per minute (bpm), the food product may contain 15.1 percent (%) of the metabolite content. At 48 hours of the acoustic treatment using incremental tempo from 46 beats per minute (bpm) to 400 beats per minute (bpm), the food product may contain 13 percent (%) of the metabolite content. At 72 hours of the acoustic treatment using incremental tempo from 46 beats per minute (bpm) to 400 beats per minute (bpm), the food product may contain 12 percent (%) of the metabolite content.

At zero hours of the acoustic treatment using decremental tempo from 400 beats per minute (bpm) to 46 beats per minute (bpm), the food product may contain 15.7 percent (%) of the metabolite content. At 12 hours of the acoustic treatment using decremental tempo from 400 beats per minute (bpm) to 46 beats per minute (bpm), the food product may contain 13.2 percent (%) of the metabolite content. At 24 hours of the acoustic treatment using decremental tempo from 400 beats per minute (bpm) to 46 beats per minute (bpm), the food product may contain 12.5 percent (%) of the metabolite content. At 48 hours of the acoustic treatment using decremental tempo from 400 beats per minute (bpm) to 46 beats per minute (bpm), the food product may contain 11.5 percent (%) of the metabolite content. At 72 hours of the acoustic treatment using decremental tempo from 400 beats per minute (bpm) to 46 beats per minute (bpm), the food product may contain 10 percent (%) of the metabolite content.

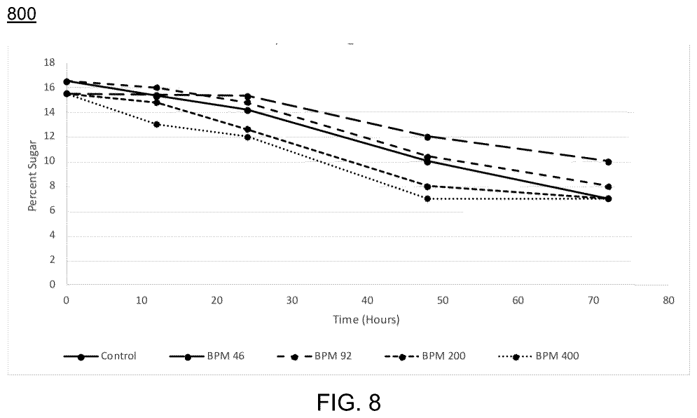

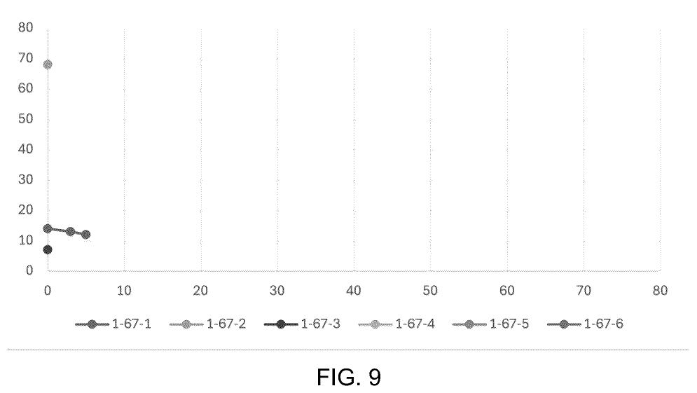

FIG. 8 depicts a graph 800 representing the metabolite content formation rate measured over time. An x-axis of the graph 800 may represent a number of hours the food product may have undergone the acoustic treatment. A y-axis of the graph 800 may represent the percentage (%) of the sugar in the food product.

At zero hours of the acoustic treatment at controlled environment, the food product may contain 16.5 percent (%) of the metabolite content. At 12 hours of the acoustic treatment at controlled environment, the food product may contain 15.3 percent (%) of the metabolite content. At 24 hours of the acoustic treatment at controlled environment, the food product may contain 14.2 percent (%) of the metabolite content. At 48 hours of the acoustic treatment at controlled environment, the food product may contain 10 percent (%) of the metabolite content. At 72 hours of the acoustic treatment at controlled environment, the food product may contain 7 percent (%) of the metabolite content.

At zero hours of the acoustic treatment using 46 beats per minute (bpm), the food product may contain 15.5 percent (%) of the metabolite content. At 12 hours of the acoustic treatment using 46 beats per minute (bpm), the food product may contain 15.4 percent (%) of the metabolite content. At 24 hours of the acoustic treatment using 46 beats per minute (bpm), the food product may contain 15.3 percent (%) of the metabolite content. At 48 hours of the acoustic treatment using 46 beats per minute (bpm), the food product may contain 12 percent (%) of the metabolite content. At 72 hours of the acoustic treatment using 46 beats per minute (bpm), the food product may contain 10 percent (%) of the metabolite content.

At zero hours of the acoustic treatment using 92 beats per minute (bpm), the food product may contain 16.5 percent (%) of the metabolite content. At 12 hours of the acoustic treatment using 92 beats per minute (bpm), the food product may contain 16 percent (%) of the metabolite content. At 24 hours of the acoustic treatment using 92 beats per minute (bpm), the food product may contain 14.8 percent (%) of the metabolite content. At 48 hours of the acoustic treatment using 92 beats per minute (bpm), the food product may contain 10.4 percent (%) of the metabolite content. At 72 hours of the acoustic treatment using 92 beats per minute (bpm), the food product may contain 8 percent (%) of the metabolite content.

At zero hours of the acoustic treatment using 200 beats per minute (bpm), the food product may contain 15.5 percent (%) of the metabolite content. At 12 hours of the acoustic treatment using 200 beats per minute (bpm), the food product may contain 14.8 percent (%) of the metabolite content. At 24 hours of the acoustic treatment using 200 beats per minute (bpm), the food product may contain 12.6 percent (%) of the metabolite content. At 48 hours of the acoustic treatment using 200 beats per minute (bpm), the food product may contain 8 percent (%) of the metabolite content. At 72 hours of the acoustic treatment using 200 beats per minute (bpm), the food product may contain 7 percent (%) of the metabolite content.

At zero hours of the acoustic treatment using 400 beats per minute (bpm), the food product may contain 15.5 percent (%) of the metabolite content. At 12 hours of the acoustic treatment using 400 beats per minute (bpm), the food product may contain 13 percent (%) of the metabolite content. At 24 hours of the acoustic treatment using 400 beats per minute (bpm), the food product may contain 12 percent (%) of the metabolite content. At 48 hours of the acoustic treatment using 400 beats per minute (bpm), the food product may contain 7 percent (%) of the metabolite content. At 72 hours of the acoustic treatment using 400 beats per minute (bpm), the food product may contain 7 percent (%) of the metabolite content.

FIG. 9 depicts a graph 900 representing a potential alcohol level measured over time. An x axis of the graph 900 may represent a number of hours the food product may have undergone the acoustic treatment. A y axis of the graph 900 may represent the potential alcohol level in the food product. At zero hours of the acoustic treatment, the food product may contain the alcohol level in a range from 7 percent (%) to 68 percent (%). At three hours of the acoustic treatment, the alcohol level in the food product may be 13 percent. At five hours of the acoustic treatment, the alcohol level in the food product may be 12 percent (%).

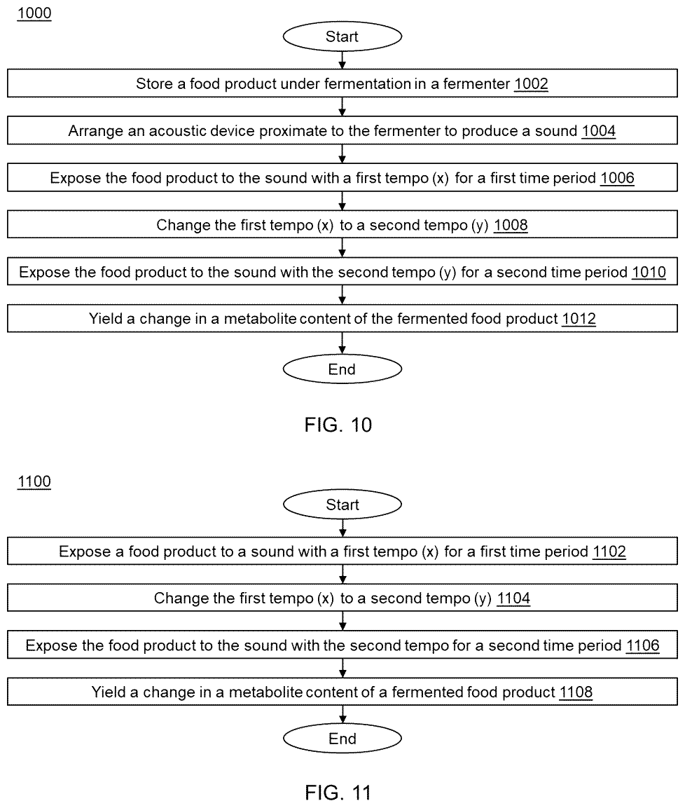

FIG. 10 depicts a flowchart of a method 1000 for enhancing the metabolite content formation rate of the food product under the fermentation using the acoustic device 6.

At step 1002, the food product under the fermentation may be stored in the fermenter 1.

At step 1004, the acoustic device 6 may be arranged proximate to the fermenter 1 to produce the sound.

At step 1006, the stored food product may be exposed to the sound with the first tempo (x) for the first time period. The sound may be generated from the acoustic device 6.

At step 1008, the first tempo (x) may be changed to the second tempo (y) using the computing device.

At step 1010, the stored food product may be exposed to the sound with the second tempo (y) for the second time period. The sound may be generated from the acoustic device 6.

At step 1012, the change in the metabolite content formation rate of the fermented food product may be yielded.

FIG. 11 depicts a flowchart of a method 1100 for enhancing the metabolite content formation rate of the food product under the fermentation using the acoustic devices 6.

At step 1102, the food product stored in the fermenter 1 may be exposed to the sound with the first tempo (x) for the first time period. The sound with the first tempo (x) may be generated from the acoustic device 6.

At step 1104, the first tempo (x) may be changed into the second tempo (y) using the computing device.

At step 1106, the food product stored in the fermenter 1 may be exposed to the sound with the second tempo (y) for the second time period. The sound with the second tempo (y) may be generated from the acoustic device 6 rather than the acoustic device 6 generating the sound with the first tempo (x).

At step 1108, the change in the metabolite content formation rate of the fermented food product may be yielded.

Although several embodiments of the disclosure are illustrated and described in connection with particular features and formulations, the present invention can be adapted for use with a wide variety of formulations. Other embodiments and equivalents have are envisioned within the scope of the claims. Various features of the disclosure have been particularly shown and described in connection with the illustrated embodiments. However, it must be understood that the particular embodiments merely illustrate and that the invention is to be given its fullest interpretation within the terms of the claims.

1. A method for modifying a rate of metabolite formation of a food product under fermentation, the method comprising:
a) exposing the food product to a fermentation process;
b) providing at least one acoustic device(s) to produce an at least one sound;
c) exposing said food product to said at least one sound with a first tempo ranging from 46 beat per minute (bpm) to 400 beats per minute for a first time period, ranging from 0 hour to 72 hours;
d) changing said first tempo to a second tempo differing from said first tempo by at least 30 bpm and within the range of 46 bpm to 400 bpm, and exposing said food product to said second tempo for a second time period ranging from 0 hours to 72 hours; and
e) yielding a change in said rate of metabolite formation, wherein said metabolite content are a percentage of sugar reduced from 16.5% to as low as 4%, an alcohol content increased from 12% to 18%, and a pH level reduced from 5.9 to 4.3.

2. (canceled)

3. The method of claim 1, wherein said at least one acoustic device is submerged in said fermented food product during said fermentation process.

4. The method of claim 1, wherein the fermented food product is selected to be in a liquid form, in a semi-liquid form, or a combination thereof.

5. (canceled)

6. (canceled)

7. (canceled)

8. The method of claim 1, wherein a frequency of the at least one sound is in a range from 119 Hertz (Hz) to 230 Hertz (Hz).

9. The method of claim 1, wherein a decibel level of the at least one sound is in a range from 0.01 decibel (dB) to 200 decibel (dB).

10. (canceled)

11. The method of claim 1, wherein arranging the at least one acoustic device(s), and are spaced out at about 27,000 cubic feet apart from each other in a fermenter.

12. (canceled)

13. (canceled)

14. (canceled)

15. (canceled)

16. (canceled)

17. (canceled)

18. (canceled)

19. A method for modifying a metabolite composition of a fermented food product, comprising:
a) exposing said food product to at least one acoustic device producing a sound with a first tempo selected from a range of 46 bpm to 400 bpm, at a frequency of 119 Hz to 230 Hz, and a sound pressure level between 79 dB to 100 dB;
b) maintaining acoustic exposure for a duration between 0 hours to 72 hours;
c) wherein said sound causes a reduction in sugar content from 16.5% to less than 10%, altering a flavor profile confirmed by sensory evaluation and UV analysis.

20. The method of claim 19, wherein the at least one sound is produced through at least one acoustic device placed external to at least one fermenter that is adapted to store the food product under fermentation.

21. The method of claim 1, wherein said percent sugar in said food product is reduced from 16.5% to 7% over 72 hours, under exposure of said food product to said at least one sound having said first tempo of 92 bpm and said frequency of 119 Hz to 197 Hz.
